(19) United States
(12) Patent Application Publication
(10) Pub. No.: US 2024/0212694 A1
(43) Pub. Date: Jun. 27, 2024

(54) MEDIA RATINGS WATERMARK ENCODING

(71) Applicant: iBiquity Digital Corporation, Columbia, MD (US)

(72) Inventor: Jeffrey DETWEILER, Ellicott City, MD (US)

(21) Appl. No.: 18/508,207

(22) Filed: Nov. 13, 2023

Related U.S. Application Data
(60) Provisional application No. 63/476,378, filed on Dec. 21, 2022.

(51) Int. Cl. G10L 19/018; G06F 16/60

(52) U.S. Cl. CPC G10L 19/018; G06F 16/60

(57) ABSTRACT

A method operable in a receiver comprises the steps of: receiving an audio signal from a broadcaster; obtaining digital information comprising an identifier associated with the broadcaster; retrieving an audio watermark associated with the identifier; encoding the audio watermark in the audio signal; and outputting an acoustic signal based on the encoded audio signal so that the audio watermark can be sensed by a listening device without being audible by a human listener.

### FIELD

The present invention relates to media ratings watermark encoding.

### BACKGROUND

In radio or television broadcasting, measurements of audience reach and preferences are used in order to allow broadcasters to, for example, make programming decisions, increase listener satisfaction and analyze and leverage radio advertising strategies. As such, a reliable audience tracking system is needed.

Many existing tracking systems rely on audio watermarking a station identification onto audio signal being broadcast by the broadcaster using, for example, the Nielsen Portable People Meter™ (PPM) ratings watermark, so that the watermark can be detected by a separate listening device carried by a user who may be listening to a receiver, while at the same time using psychoacoustic masking to remain inaudible to the user. The listening device extracts and decodes the watermark from the audio signal and stores the listening data for later retrieval.

Referring to FIG. 1, there is illustrated an exemplary encoding module 10 for audio watermarks of the type disclosed in US Patent 5,450,490 (Jensen et al.), the disclosure of which is herein incorporated by reference in its entirety.

Before being broadcast as part of a radio or television program, an audio signal to be encoded is transmitted to an input terminal 11 of the encoding module 10. The encoding module typically comprises a digital signal processor which divides the audio signal into overlapping windows or frames of a given duration and applies a Fourier transform 12 to each windowed signal to obtain its representation in the frequency domain and identify its frequency components. Alternatively, the time-to-frequency domain transformation may be carried out by other techniques, such as wavelet transform.

The audio watermark to be encoded is received from the radio station at a second input 14 of the encoding module 10. In block 13, the audio signal is evaluated to determine the potential of each frequency component of the audio signal to mask the frequencies of the audio watermark to be encoded into the windowed audio signal.

A code generator 15 of the encoding module 10 responds by producing its unique group of code frequency components and assigns an amplitude and phase to each based on the evaluation. The code frequency components can be arranged at equal frequency intervals in a range extending from a frequency value slightly greater than 2 kHz to a frequency value slightly less than 3 kHz. Alternatively, other ranges of frequency, other frequency intervals or any combination thereof may be used.

The code components are then provided at a first input of a summing circuit 16, with the frequency transformed audio signal being provided at its second input. The summing circuit 16 embeds the watermark by altering the amplitudes or phases of the selected frequency components and adding the code components determined by the code generator 15, and outputs the encoded audio signal.

This process is repeated for successive time windows of the audio signal, so that it will be appreciated, different components may be used for encoding the watermark for different time windows of the audio signal. Equally, the watermark need not be embedded continuously in the audio signal and may be embedded in intermittent windows of the audio signal.

A reverse Fourier transform 17 is applied to convert the encoded audio signal back to the time domain, and this signal is provided at the output 18 of the encoding module 10. It will be appreciated that, if any technique other than Fourier transform was used at block 12 of the encoding module 10, then an appropriate reverse method should be carried out. For example, if the time-to-frequency transformation was carried out by wavelet transform, as mentioned above, then the original signal can be reproduced by applying the reverse wavelet transform in adding together the daughter wavelets, each weighted by its associated coefficient. Similarly, any reverse operation can be envisioned depending on the transformation performed in block 12.

Subsequently, the encoded audio signal is provided from the output terminal 18 of the encoding module 10 to a pre-amplifier 182. The pre-amplifier 182 adjusts the overall amplitude of the signal to be broadcast, to ensure that the power of the broadcast signal is sufficient for receivers to tune into the station. Thus, for passages of quiet programming, the signal may be significantly amplified whereas for passages of loud programming, less amplification can be applied. This amplification however can tend to clip and therefore distort components of the audio signal and therefore effect the ability of a listening device to detect the watermark carried by the audio signal.

In any case, the encoded audio signal then passes through a modulator 184, typically a frequency modulator using the encoded audio signal to adjust the phase of a carrier associated with the broadcaster, before transmission through a transmitter antenna 19. The transmitter 19 can be any of an omnidirectional, semi-directional or directional antenna and can comprise a single antenna or a plurality of transmitting antenna elements.

Before transmission, further audio processing may be performed by an audio-processor (not shown) in order to optimize the broadcast audio signal. Without limitation, this processing may include noise cancellation, overmodulation protection, or noise control. Again, any such post-processing can affect the ability of a listening device to detect the watermark carried by the audio signal.

The modulated signal is transmitted through the air and received by a receiver (not shown). Again, air being a lossy transmission medium, noise is introduced, effecting the ability of a listening device to detect the watermark carried by the audio signal.

Alternatively, the encoded audio signal either at the output of the summer 16 or once it has reverted to the time domain after the transform 17 can be encoded digitally and transmitted using an appropriate digital radio scheme such as DAB in Europe, CDR in China, ISDB-T in Japan or HD Radio in United States.

A receiver can be tuned to detect the frequency of the carrier wave and in a reverse process, the signal is demodulated, and the encoded audio signal is amplified and output through a speaker where it may be detected by a listening device. Again, any audio processing performed on the receiving side can affect the ability of a listening device to detect the watermark carried by the audio signal.

The accumulation of the above and potentially other distortions of the encoded signal may mean that a PPM listening device may be unable to successfully extract the audio watermark from the received encoded audio signal.

U.S. Pat. No. 8,768,005 (Voltair), the disclosure of which is herein incorporated by reference in its entirety, discloses a device for extracting a watermark signal from an output signal of a watermarking encoder in which the output signal includes an input signal portion corresponding to an input signal to the watermarking encoder and a watermark signal portion corresponding to the watermark signal. The device includes an input configured to receive the input signal and the output signal and an adjustment signal generator configured to generate a gain adjustment signal and a delay adjustment signal based on the input signal and the output signal, a gain and delay adjustor configured to adjust gain and delay of the output signal or the input signal based on the gain adjustment signal and the delay adjustment signal, respectively, to generate an adjusted output signal or an adjusted input signal, respectively, and an output configured to transmit a difference between the input signal and the adjusted output signal or a difference between the adjusted input signal and the output signal as the watermark signal.

There remains a need for a watermark encoding method suitable for reliably tracking ratings without causing degradation of the listenability for a user.

### SUMMARY

According to the present invention, there is provided a method operable in an audio receiver for encoding an audio watermark according to claim 1.

According to a second aspect, there is provided an audio receiver configured to perform the method of the invention.

In embodiments, the station information is known to the audio receiver and is used to locally construct the watermark in the receiver output without suffering degradation of the watermark through broadcast or the signal environment so providing higher decodability rates.

Embodiments provide a digital radio media rating watermark encoding method and system for the local generation of a Nielsen Portable People Meter™ (PPM) technology ratings watermark in a receiver output.

In embodiment of the invention where a digital side band is available, then the information for the watermark can be transmitted separately from the audio signal to the receiver, where it is then decoded and added to the audio signal.

### BRIEF DESCRIPTION OF THE DRAWINGS

Embodiments of the invention will now be described, by way of example, with reference to the accompanying drawings, in which:

FIG. 1 illustrates an exemplary encoding module for embedding an audio watermark into an audio signal to be broadcast.

FIG. 2 illustrates schematically an audio receiver according to an embodiment of the present disclosure.

### DESCRIPTION OF THE EMBODIMENTS

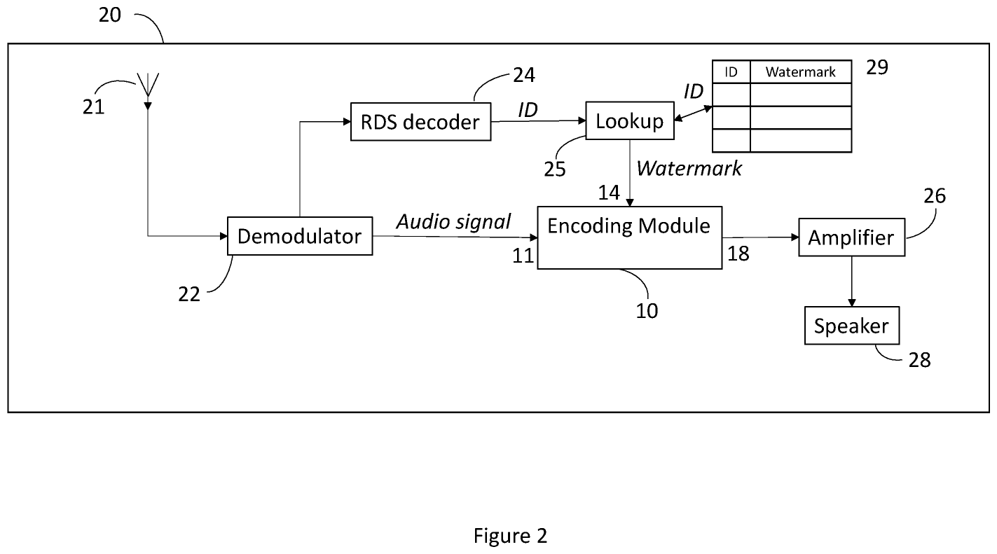

Referring now to FIG. 2, there is shown an audio receiver, according to an embodiment of the present invention, comprising a receiver 20 for receiving a broadcast radio signal through an antenna 21. The present description focuses on the radio broadcast comprising only an audio signal, but it will be appreciated that the audio signal may be broadcast as a part of a television broadcast or any form of multimedia content. In the present embodiment the broadcast audio signal typically does not comprise an audio watermark.

In the embodiment, the receiver 20 is configured to receive a frequency modulated, FM, radio signal carrying an analog audio signal as well as a limited amount of digital data, for example in compliance with the RDS standard.

It will be appreciated that in variants of the embodiment, the receiver 20 could be configured to receive an amplitude modulated, AM, radio signal. Where the AM radio signal is transmitted as an analogue signal, it may carry a limited amount of digital information such as in the case of the low-rate data service (LRDS) proposed by the US National Association of Broadcasters.

Alternatively, the receiver 20 could be configured to receive a digital broadcast signal, such as a HD Radio broadcast in the United States, ISDB-T in Japan, CDR in China or Digital Audio Broadcasting (DAB) broadcast in Europe, which is decoded in order to provide an analog audio signal. In any case, for analog FM or digital broadcast, the audio signal typically comprises stereo components.

Note that in the case of HD Radio in the United States, a digital version of an analog FM or AM station is broadcast adjacent the analog signal and, in that case, any required digital information for the analog station can be obtained from the adjacent digital broadcast. In the embodiment, when a user selects a radio station through an interface (not shown), a tuner (not shown) adjusts to detect the desired radio signal carrier frequency for the selected radio station. The detected signal is provided to a demodulator 22 which outputs an audio signal.

Where the radio signal is received by AM broadcast, the audio signal may be extracted using an envelope detector, and if the audio signal is received by digital broadcast, a digital decoder can extract the audio signal.

In any case, a time varying analog audio signal is available within the receiver 20 and this would normally be provided to an amplifier 26 before being fed through one or more speakers 28 which emit an acoustic audio signal.

In the embodiment, the demodulated signal is also fed to an RDS decoder 24 which extracts additional digital data associated with the audio signal. The digital data includes a digital broadcast identification, ID, of a radio station, and may comprise additional data such as the title of a song being played, or other digital information about the broadcast. It will be appreciated that the digital information may comprise, for example, a list of alternative frequencies for the same broadcasting station, radio text, traffic announcements, or other networks or stations information. Any such digital information can be displayed on a user interface of the receiver.

In the case of a digital radio broadcast, the digital data identifying the radio station is encoded along with the audio signal. For example, for HD Radio, data identifying the station may be obtained from the Station Information Service (SIS) and the Service Information Guide (SIG).

In some implementations, the receiver 20 can form part of a hybrid radio of the type promoted by RadioDNS. In such a case, any digital data required for use by the receiver 20 may be received through an Internet Protocol, IP port of the hybrid radio.

In the example, the broadcast ID of the radio station is in the form of a 4-digit hexadecimal Programme Identification (PI) code, but other alternatives can be envisioned. Again, it will be appreciated that alternative decoders may be used to extract the digital broadcast identifier if the digital data is transmitted using other communication standards.

The broadcast ID is used by a lookup function 25 to retrieve watermark information associated with the radio station. In the embodiment, the receiver 20 includes a lookup table 29 populated with watermark information for each broadcast ID. Such information can be pre-programmed into the receiver 20, or the information can be retrieved from the broadcast signal where this is provided in digital sideband information, for example using the DAB Transparent Data Channel (TDC), or, if available, the information can be retrieved from a server through an IP connection with a hybrid radio receiver.

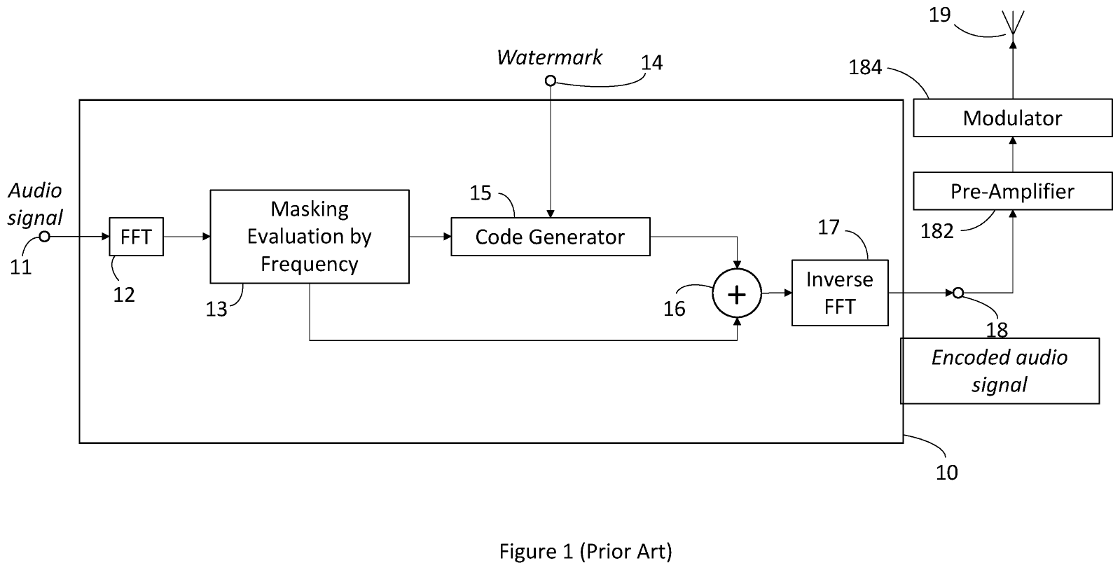

The demodulated audio signal and the audio watermark are then provided by the demodulator 22 and lookup function 25 respectively as inputs to an encoding module 10 which can be of the conventional type described in relation to FIG. 1 and which embeds the audio watermark into the audio signal in the manner described above in relation to FIG. 1. It will be further appreciated that any alternative configuration or implementation mentioned in the passages of the description relating to FIG. 1 may be applied here.

As described in relation to FIG. 1, the encoding module 10 adds the audio watermark to a time domain audio signal received at an input terminal 11. In alternative embodiments, the watermark information could be added digitally, for example, before the received digital data encoding an audio signal is decoded into the time domain.

In any case, the encoded audio signal provided at the output port 18 of the encoding module 18 is sent to an amplifier 26 before being output through the speaker(s) 28.

It will be appreciated that using this approach, the watermark is embedded in the audio signal without degradation of the encoded audio signal due to pre-transmission audio processing steps, lossy signal medium or indeed any signal filtering that may be applied in the receiver 20, so improving the detection reliability of any PPM device sensing the signal output by the speaker(s) 28 without needing the watermark to be audible by a human listener.

Many other variations than those described herein will be apparent from this document. For example, depending on the embodiment, certain acts, events, or functions of any of the methods and algorithms described herein can be performed in a different sequence, can be added, merged, or left out altogether (such that not all described acts or events are necessary for the practice of the methods and algorithms). Moreover, in certain embodiments, acts or events can be performed concurrently, such as through multi-threaded processing, interrupt processing, or multiple processors or processor cores or on other parallel architectures, rather than sequentially. In addition, different tasks or processes can be performed by different machines and computing systems that can function together.

The various illustrative logical blocks, modules, methods, and algorithm processes and sequences described in connection with the embodiments disclosed herein can be implemented as electronic hardware, computer software, or combinations of both. To clearly illustrate this interchangeability of hardware and software, various illustrative components, blocks, modules, and process actions have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of this document.

The various illustrative logical blocks and modules described in connection with the embodiments disclosed herein can be implemented or performed by a machine, such as a general purpose processor, a processing device, a computing device having one or more processing devices, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor and processing device can be a microprocessor, but in the alternative, the processor can be a controller, microcontroller, or state machine, combinations of the same, or the like. A processor can also be implemented as a combination of computing devices, such as a combination of a DSP and a microprocessor, a plurality of microprocessors, one or more microprocessors in conjunction with a DSP core, or any other such configuration.

Embodiments of the audio receiver and method described herein are operational within numerous types of general purpose or special purpose computing system environments or configurations. In general, a computing environment can include any type of computer system, including, but not limited to, a computer system based on one or more microprocessors, a mainframe computer, a digital signal processor, a portable computing device, a personal organizer, a device controller, a computational engine within an appliance, a mobile phone, a desktop computer, a mobile computer, a tablet computer, a smartphone, and appliances with an embedded computer, to name a few.

Such computing devices can typically be found in devices having at least some minimum computational capability, including, but not limited to, personal computers, server computers, hand-held computing devices, laptop or mobile computers, communications devices such as cell phones and PDA's, multiprocessor systems, microprocessor-based systems, set top boxes, programmable consumer electronics, network PCs, minicomputers, mainframe computers, audio or video media players, and so forth. In some embodiments the computing devices will include one or more processors. Each processor may be a specialized microprocessor, such as a digital signal processor (DSP), a very long instruction word (VLIW), or other micro-controller, or can be conventional central processing units (CPUs) having one or more processing cores, including specialized graphics processing unit (GPU)-based cores in a multi-core CPU.

The process actions or operations of a method, process, or algorithm described in connection with the embodiments disclosed herein can be embodied directly in hardware, in a software module executed by a processor, or in any combination of the two. The software module can be contained in computer-readable media that can be accessed by a computing device. The computer-readable media includes both volatile and nonvolatile media that is either removable, non-removable, or some combination thereof. The computer-readable media is used to store information such as computer-readable or computer-executable instructions, data structures, program modules, or other data. By way of example, and not limitation, computer readable media may comprise computer storage media and communication media.

Computer storage media includes, but is not limited to, computer or machine readable media or storage devices such as Bluray discs (BD), digital versatile discs (DVDs), compact discs (CDs), floppy disks, tape drives, hard drives, optical drives, solid state memory devices, RAM memory, ROM memory, EPROM memory, EEPROM memory, flash memory or other memory technology, magnetic cassettes, magnetic tapes, magnetic disk storage, or other magnetic storage devices, or any other device which can be used to store the desired information and which can be accessed by one or more computing devices.

A software module can reside in the RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an application specific integrated circuit (ASIC). The ASIC can reside in a user terminal.

Alternatively, the processor and the storage medium can reside as discrete components in a user terminal.

The phrase “non-transitory” as used in this document means “enduring or long-lived”. The phrase “non-transitory computer-readable media” includes any and all computer-readable media, with the sole exception of a transitory, propagating signal. This includes, by way of example and not limitation, non-transitory computer-readable media such as register memory, processor cache and random-access memory (RAM).

The phrase “audio signal” is a signal that is representative of a physical sound.

Retention of information such as computer-readable or computer-executable instructions, data structures, program modules, and so forth, can also be accomplished by using a variety of the communication media to encode one or more modulated data signals, electromagnetic waves (such as carrier waves), or other transport mechanisms or communications protocols, and includes any wired or wireless information delivery mechanism. In general, these communication media refer to a signal that has one or more of its characteristics set or changed in such a manner as to encode information or instructions in the signal. For example, communication media includes wired media such as a wired network or direct-wired connection carrying one or more modulated data signals, and wireless media such as acoustic, radio frequency (RF), infrared, laser, and other wireless media for transmitting, receiving, or both, one or more modulated data signals or electromagnetic waves. Combinations of the any of the above should also be included within the scope of communication media.

Further, one or any combination of software, programs, computer program products that embody some or all of the various embodiments of the audio receiver and method described herein, or portions thereof, may be stored, received, transmitted, or read from any desired combination of computer or machine-readable media or storage devices and communication media in the form of computer executable instructions or other data structures.

Embodiments of the audio receiver and method described herein may be further described in the general context of computer-executable instructions, such as program modules, being executed by a computing device. Generally, program modules include routines, programs, objects, components, data structures, and so forth, which perform particular tasks or implement particular abstract data types. The embodiments described herein may also be practiced in distributed computing environments where tasks are performed by one or more remote processing devices, or within a cloud of one or more devices, that are linked through one or more communications networks. In a distributed computing environment, program modules may be located in both local and remote computer storage media including media storage devices. Still further, the aforementioned instructions may be implemented, in part or in whole, as hardware logic circuits, which may or may not include a processor.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the above detailed description has shown, described, and pointed out novel features as applied to various embodiments, it will be understood that various omissions, substitutions, and changes in the form and details of the devices or algorithms illustrated can be made without departing from the scope of the disclosure. As will be recognized, certain embodiments of the inventions described herein can be embodied within a form that does not provide all of the features and benefits set forth herein, as some features can be used or practiced separately from others.

1. A method operable in a receiver comprising the steps of:
receiving an audio signal from a broadcaster;
obtaining digital information comprising an identifier associated with the broadcaster;
retrieving an audio watermark associated with the identifier;
encoding the audio watermark in the audio signal; and
outputting an acoustic signal based on the encoded audio signal so that the audio watermark can be sensed by a listening device without being audible by a human listener.

2. The method of claim 1, wherein the audio signal is comprised in one of a radio broadcast, a television broadcast or a multimedia broadcast.

3. The method of claim 2, comprising receiving the audio signal from the broadcaster by one of Frequency Modulation, FM, Amplitude Modulation, AM, or digital broadcast.

4. The method of claim 3, comprising obtaining the digital information through the Radio Data System, RDS of an FM broadcast.

5. The method of claim 1, comprising obtaining the digital information through an Internet Protocol, IP, port of a hybrid radio receiver.

6. The method of claim 1, wherein the encoding the audio watermark in the audio signal comprises the steps of:
dividing the audio signal in a plurality of frames of a preset duration;
applying a time-frequency transform to each frame to determine frequency components of the audio signal;
determining the potential of the frequency components of the audio signal to hide the frequencies of the audio watermark;
generating at least one code frequency component associated with the audio watermark, the code frequency component having an amplitude based on the determined potential of the frequency component of the audio signal to hide the frequencies of the audio watermark;
combining the at least one code frequency component associated with the audio watermark and the determined frequency components of the audio signal to provide an encoded signal; and
applying a reverse frequency-time transform to the encoded signal.

7. The method of claim 6, wherein the generating at least one code frequency component associated with the audio watermark comprises:
generating a plurality of code frequency components associated with the audio watermark, wherein each code frequency component of the plurality of code frequency components has an amplitude based on the determined potential of the frequency component of the audio signal to hide the frequencies of the audio watermark; and
adding the plurality of code frequency components associated with the audio watermark to the audio signal.

8. The method of claim 7, wherein the adding the plurality of code frequency components associated with the audio signal comprises adding the code frequency components associated with the audio signal to different time windows of the audio signal.

9. The method of claim 6, wherein the time-frequency transform is a Fast-Fourier transform.

10. The method of claim 1, wherein the digital information further comprises at least one of a picture, a title of a song being played, a name of a radio station, a list of other radio stations, a list of alternative frequencies for a radio station, radio text, traffic announcements, other networks or stations information.

11. The method of claim 1, wherein said retrieving an audio watermark associated with the identifier comprises one of: using the identifier to retrieve the audio watermark from a look-up table available at the receiver; retrieving the audio watermark from digital information contained in a broadcast; or using the identifier to retrieve the audio watermark from a server through an IP connection with the receiver.

12. An audio receiver comprising a receiver capable of receiving a broadcast audio signal and a processor configured to carry out the method of claim 1.
